(19) United States
(12) Patent Application Publication
(10) Pub. No.: US 2021/0081641 A1
(43) Pub. Date: Mar. 18, 2021

(54) FINGERPRINT AUTHENTICATION METHOD AND SYSTEM FOR REJECTING SPOOFING ATTEMPTS

(71) Applicant: FINGERPRINT CARDS AB, Göteborg (SE)

(72) Inventor: Eric SETTERBERG, VÄSTRA FRÖLUNDA (SE)

(73) Assignee: FINGERPRINT CARDS AB, Göteborg (SE)

(21) Appl. No.: 16/612,946

(22) PCT Filed: Apr. 26, 2018
(86) PCT No.: PCT/SE2018/050431

§ 371 Date: Nov. 12, 2019

(30) Foreign Application Priority Data
May 19, 2017 (SE) 1750629-6

(51) Int. Cl. G06K 9/00; G06F 21/32

(52) U.S. Cl. CPC G06K 9/0012; G06K 9/00906; G06F 21/32; G06K 9/00926; G06K 9/001

(57) ABSTRACT

A method of authenticating a user by means of a fingerprint authentication system, comprising the steps of receiving a touch by a candidate finger probe; acquiring a first candidate fingerprint image of the candidate finger probe; determining a first authentication representation based on the first candidate fingerprint image; retrieving a stored enrollment representation of an enrolled fingerprint of the user; comparing the first authentication representation with the enrolment representation; determining a liveness score for the candidate finger probe; and when the first authentication representation matches with the stored enrolment representation, and the liveness score indicates a likely spoof: providing a signal indicating a failed authentication; determining a first anti-spoofing representation based on the first candidate fingerprint image; and storing the first anti-spoofing representation.

### FIELD OF THE INVENTION

The present invention relates to a fingerprint authentication system, and to a method of authenticating a user by means of a fingerprint authentication system.

### BACKGROUND OF THE INVENTION

Various types of biometric systems are used more and more in order to provide for increased security and/or enhanced user convenience.

In particular, fingerprint sensing systems have been adopted in, for example, consumer electronic devices, thanks to their small form factor, high performance, and user acceptance.

For continued trust in fingerprint sensing systems, it is important to provide fingerprint sensing systems with high performance in terms of convenience as well as security. In particular, it would be desirable to provide fingerprint sensing systems that are capable of rejecting attempts to get a positive authentication result using a fake finger.

Various fingerprint sensing systems, employing so-called anti-spoofing measures, have been suggested.

For example, US2009/0316963 discloses a fingerprint sensor including a finger sensing area and a controller. The controller aligns authentication data and enrollment data and performs spoof attempt detection based on corresponding pairs of finger features and their spatial locations in the aligned enrollment and authentication data.

However, it would still be desirable to provide for authentication with an improved performance, in particular in respect of rejecting spoofing attempts.

### SUMMARY

In view of the above-mentioned and other drawbacks of the prior art, it is an object of the present invention to provide for improved authentication, in particular in respect of rejecting spoofing attempts.

According to a first aspect of the present invention, it is therefore provided a method of authenticating a user by means of a fingerprint authentication system, the method comprising the steps of: receiving a touch by a candidate finger probe; acquiring a first candidate fingerprint image indicating a surface topography of the candidate finger probe; determining a first authentication representation based on the first candidate fingerprint image; retrieving a stored enrollment representation of an enrolled fingerprint of the user; comparing the first authentication representation with the enrolment representation; determining a liveness score for the candidate finger probe; and when the liveness score indicates a likely spoof: providing a signal indicating a failed authentication; determining a first anti-spoofing representation based on the first candidate fingerprint image; and storing the first anti-spoofing representation.

It should be noted that the steps of methods according to embodiments of the present invention need not necessarily be in the order recited in the claims.

It should also be noted that a fingerprint authentication system may be comprised in a stand-alone electronic device, such as a mobile communication device, a watch or a smart card, or may be formed by interconnected devices, such as a computer and a fingerprint acquisition device connected to the computer.

The fingerprint sensing arrangement may, for example, be a capacitive fingerprint sensing arrangement, detecting a measure indicative of the capacitive coupling between each sensing element in an array of sensing elements and a finger surface touching the sensing arrangement surface. Sensing elements at locations corresponding to ridges in the fingerprint will exhibit a stronger capacitive coupling to the finger than sensing elements at locations corresponding to valleys in the fingerprint.

However, the various embodiments of the present invention are not limited to a particular fingerprint sensing technology, but are equally applicable to any sensing technology capable of providing an indication of the surface topography of the top surface of the candidate finger probe, for instance, acoustic, optical, thermal or piezo-electric fingerprint sensing arrangements etc.

Furthermore, the fingerprint authentication system according to embodiments of the present invention may be embodied as a system of components, or in a single component, such as an integrated circuit.

The above-mentioned liveness score that is determined for the candidate finger probe (which may or may not be a real finger) may be based on one or several fingerprint images and/or on one or several auxiliary properties that may be used for indicating a likelihood of a spoof attempt.

The present invention is based upon the realization that only a small portion of a spoof made from a latent fingerprint is likely to be of sufficiently high quality to potentially achieve a successful authentication, and that the most likely way an impostor would use such a spoof would be to move it between authentication attempts to try to align the small high quality portion, having a top surface with a surface topography of sufficient quality to result in a good fingerprint image, with the sensing area of the fingerprint sensor using trial-and-error. The present inventor has further realized that this attack pattern, in combination with a liveness score, can be used to identify a likely spoof, and that an anti-spoofing representation of the likely spoof can be determined and stored for increasing the chances of rejecting subsequent spoofing attempts, even when the small high quality portion is aligned with the sensing area of the fingerprint sensor.

By basing the anti-spoofing representation on a candidate fingerprint image indicative of the surface topography of the candidate finger probe, at least certain kinds of spoofing attempts can be identified without using sub-surface imaging techniques, allowing for the use of various fingerprint sensing techniques that are unable to sense underlying structures of a candidate finger probe, and/or facilitating processing and analysis of signals acquired from the fingerprint sensor.

In embodiments, the above-mentioned signal indicating a failed authentication may be provided when the first authentication representation matches with the stored enrolment representation, and the liveness score indicates a likely spoof.

In embodiments, the method according to the present invention may further comprise the steps of: acquiring a second candidate fingerprint image of the candidate finger probe; determining a second authentication representation based on the second candidate fingerprint image; retrieving the stored first anti-spoofing representation; comparing the second authentication representation with the first anti-spoofing representation; and when the second authentication representation matches with the first anti- spoofing representation, providing a signal indicating a failed authentication.

The first candidate fingerprint image may be acquired in connection with a first authentication attempt, and the second candidate fingerprint image may be acquired in connection with a second authentication attempt.

Using the stored first anti-spoofing representation, the second authentication attempt can be rejected even if the second authentication representation matches well with the stored enrollment representation. A good match between the second authentication representation and the first anti-spoofing representation is an indication that the second authentication attempt is with the same spoof that was identified in the first (failed) authentication attempt. Accordingly, embodiments of the present invention strengthen the defenses against spoofing attacks, especially so-called presentation attacks.

In embodiments, the method according to the invention may further comprise the step of: when the second authentication representation matches the first anti-spoofing representation: determining a second anti-spoofing representation based on the second candidate fingerprint image; and storing the second anti-spoofing representation. In other words, an anti-spoofing “template” may be expanded with anti-spoofing representations determined in connection with additional detected spoofing attempts. This may increase the precision in the rejection of subsequent spoofing attempts.

According to embodiments, a determination of whether or not the second authentication representation matches the first anti-spoofing representation may depend on a time between the first authentication attempt and the second authentication attempt.

In a so-called presentation attack, several authentication attempts may be expected over a relatively short period of time. If the time between the first authentication attempt and the second authentication attempt is relatively short, it can therefore be assumed that the probability of an ongoing presentation attack is higher than if the time is relatively long. For instance, if the time between the first authentication attempt and the second authentication attempt is less than, say, ten seconds, the probability of an ongoing presentation attack may be considered to be higher than if the time between the first authentication attempt and the second authentication attempt is longer than, say, one minute.

Accordingly, the determination of whether or not there is a match may depend on the time between the first authentication attempt and the second authentication attempt in such a way that a shorter time increases a likelihood of the second authentication representation matching the first anti-spoofing representation.

Any additional matching requirement may result in an increase of the occurrence of false rejections, which is undesirable. It would therefore be advantageous to only match an authentication representation against an anti-spoofing representation when a presentation attack or similar may reasonably occur and/or to limit the coverage of the stored anti-spoofing representation(s). To that end, it may be advantageous to discard any stored anti-spoofing representation upon receiving an indication of a successful authentication by the user.

This may, in particular, be the case when the successful authentication provides a supplementary indication of user presence, by an alternative authentication method. For instance, the successful authentication may be the result of the entry of a correct passcode (such as a password or PIN-code).

In embodiments, furthermore, the liveness score may be determined based on at least one acquired candidate fingerprint image.

Alternatively, or in combination, the fingerprint authentication system may comprise liveness sensing circuitry for sensing a liveness property of said candidate finger probe, and the liveness score may be determined further based on such liveness property.

The liveness property may, advantageously, be selected from a set of properties of the candidate finger probe including: a dimension; a relation between dimensions; a deformation property; an optical property an electrical property; and a perspiration property.

According to a second aspect of the present invention, there is provided a fingerprint authentication system for authenticating a user, comprising: a fingerprint sensing arrangement; a memory; and processing circuitry coupled to the fingerprint sensing arrangement, the processing circuitry being configured to: control the fingerprint sensing arrangement to acquire a first candidate fingerprint image of a candidate finger probe; determine a first authentication representation based on the first candidate fingerprint image; retrieve, from the memory, a stored enrollment representation of an enrolled fingerprint of the user; compare the first authentication representation with the enrolment representation; determine a liveness score for the candidate finger probe; and when the first authentication representation matches with the enrolment representation, and the liveness score indicates a likely spoof: provide a signal indicating a failed authentication; determine a first anti-spoofing representation based on the first candidate fingerprint image; and store, in the memory, the first anti-spoofing representation.

The processing circuitry may be realized as hardware and/or as software running on one or several processors.

Further embodiments of, and effects obtained through this second aspect of the present invention are largely analogous to those described above for the first aspect of the invention.

The fingerprint authentication system according to embodiments of the present invention may be included in an electronic device, further comprising a processing unit configured to control the fingerprint authentication system to carry out a fingerprint authentication of a user, and to perform at least one action only upon successful authentication of the user.

### BRIEF DESCRIPTION OF THE DRAWINGS

These and other aspects of the present invention will now be described in more detail, with reference to the appended drawings showing an example embodiment of the invention, wherein:

FIGS. 1a-b schematically illustrate an electronic device including a fingerprint sensing device according to an example embodiment of the present invention;

FIG. 2 is a block diagram of the electronic device in FIGS. 1a-b;

FIG. 3 is a schematic cross-section view of a portion of the fingerprint sensing device in FIG. 1b;

FIG. 4 is a flow-chart schematically illustrating a method according to a first example embodiment of the present invention;

FIG. 5 is a flow-chart schematically illustrating a method according to a second example embodiment of the present invention;

FIG. 6 is a schematic illustration of a spoof; and

FIGS. 7a-c are schematic representations of candidate fingerprint images acquired in an example sequence of spoofing attempts using the spoof in FIG. 6.

### DETAILED DESCRIPTION OF EXAMPLE EMBODIMENTS

In the present detailed description, various embodiments of the electronic device according to the present invention are mainly discussed with reference to a mobile phone with a substantially square fingerprint sensor being accessible through an opening in the back cover. Furthermore, the fingerprint sensor 3 and the processing circuitry are schematically indicated as being different separate components.

It should be noted that this by no means limits the scope of the present invention, which equally well includes, for example, other types of electronic devices, such as smart watches, smart cards, laptop computers etc. Furthermore, the fingerprint sensing device need not be substantially square, but could be elongated or have any other suitable shape. Moreover, the fingerprint sensing device may be arranged in any suitable location in the electronic device, such as being integrated with a button on the front or the side of the mobile phone, or arranged under a cover glass etc. In addition, the processing circuitry, or parts of the processing circuitry, may be integrated with the fingerprint sensor.

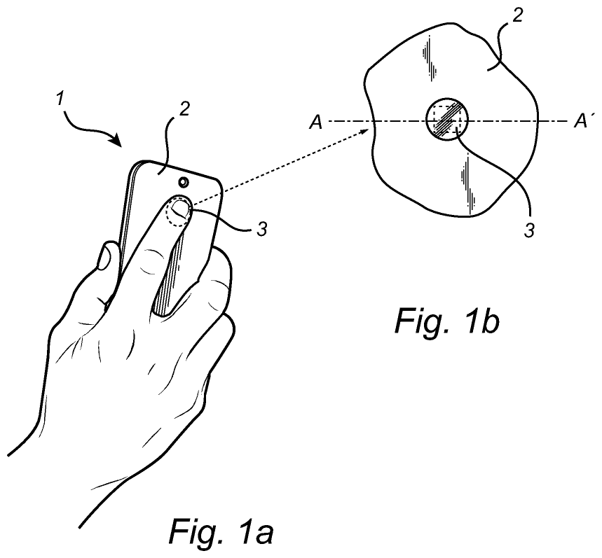

FIG. 1a schematically illustrates an example embodiment of the electronic device according to the present invention, in the form of a mobile phone 1 having a housing 2 and an integrated fingerprint sensor 3 being accessible through an opening in the housing 2. The fingerprint sensor 3 may, for example, be used for unlocking the mobile phone 1 and/or for authorizing transactions carried out using the mobile phone etc.

FIG. 1b is an enlarged view of the fingerprint sensor 3 and its integration with the housing 2.

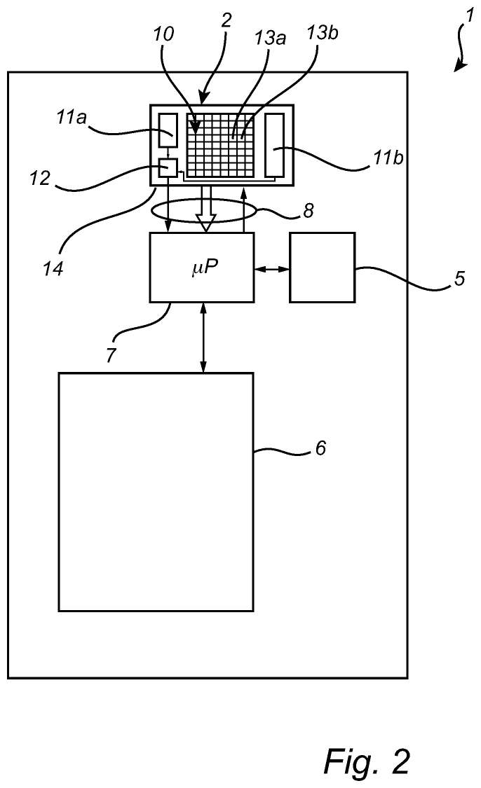

With reference to FIG. 2, which is a schematic block-diagram of the mobile phone is FIG. 1a, the mobile phone 1, in addition to the above-mentioned fingerprint sensor 3, comprises communication circuitry 5, user interface circuitry 6, processing circuitry 7, and a fingerprint sensor interface 8, here schematically indicated by the line arrows indicating control signals and the block arrow indicating data transfer.

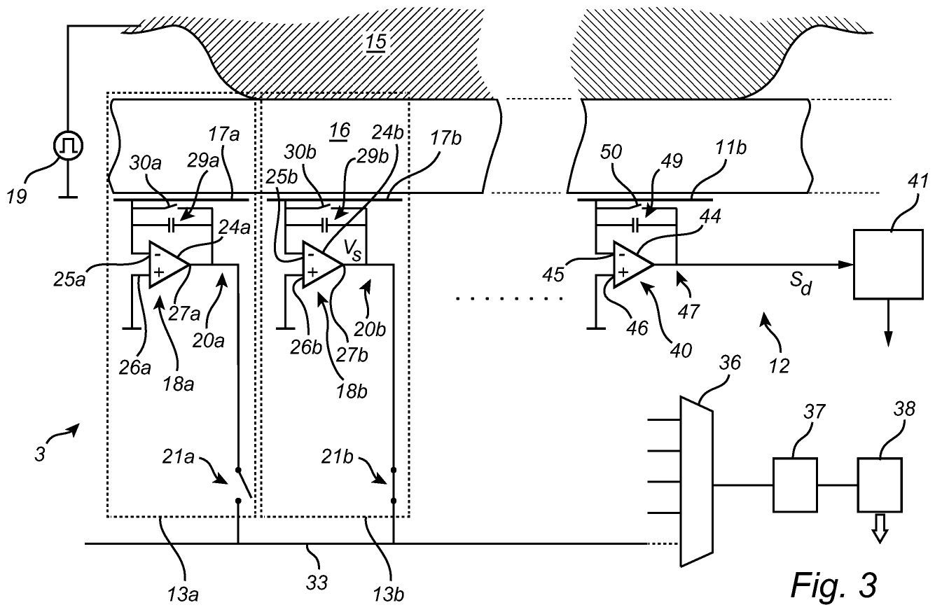

As is schematically indicated in FIG. 2, the fingerprint sensor 3 comprises a sensor array 10 and finger detecting circuitry, here provided in the form of finger detecting structures 11a-b and a finger detection circuit 12 connected to the finger detecting structures 11a-b. The sensor array 10 includes a plurality of sensing elements 13a-b (only two neighboring sensing elements are indicated with reference numerals in FIG. 2 to avoid cluttering the drawing). The fingerprint sensor 3 further comprises a finger detection output 14 for externally providing a Finger Detect and/or a Finger Lost signal from the finger detection circuit 12. Although not shown in FIG. 2, the fingerprint sensing device 3 additionally comprises readout circuitry for converting sensing signals from the sensing elements to provide a representation of a fingerprint touching the sensor surface. Exemplary readout circuitry will be described further below with reference to FIG. 3.

The above-mentioned communication circuitry 5 may, for example, comprise one or several of various antennas and control units for wireless communication, and the above-mentioned user interface circuitry 6 may, for example, comprise one or several of a display, a microphone, a speaker, and a vibration unit.

FIG. 3 is a schematic cross section of a portion of the fingerprint sensing device 3 in FIG. 1b taken along the line A-A′ with a finger 15 placed on top of a protective dielectric top layer 16 covering the sensor array 5 and the finger detecting structures 11a-b. Referring to FIG. 3, the fingerprint sensing device 3 comprises an excitation signal providing circuit 19 electrically connected to the finger via a conductive finger drive structure (not shown in FIG. 3), a plurality of sensing elements 13a-b, and a finger detection arrangement comprising the finger detecting structure 11b, and the finger detection circuit 12 connected to the finger detecting structure 11b.

As is schematically indicated in FIG. 3, each sensing element 13a-b comprises a conductive sensing structure, here in the form of a metal plate 17a-b underneath the protective dielectric top layer 16, a charge amplifier 18a-b, and selection circuitry, here functionally illustrated as a simple selection switch 21a-b for allowing selection/activation of the respective sensing element 13a-b.

The charge amplifier 18a-b comprises at least one amplifier stage, here schematically illustrated as an operational amplifier (op amp) 24a-b having a first input (negative input) 25a-b connected to the sensing structure 17a-b, a second input (positive input) 26a-b connected to sensor ground or another reference potential, and an output 27a-b. In addition, the charge amplifier 18a-b comprises a feedback capacitor 29a-b connected between the first input 25a-b and the output 27a-b, and reset circuitry, here functionally illustrated as a switch 30a-b, for allowing controllable discharge of the feedback capacitor 29a-b. The charge amplifier 18a-b may be reset by operating the reset circuitry 30a-b to discharge the feedback capacitor 29a-b.

As is often the case for an op amp 24a-b in a negative feedback configuration, the voltage at the first input 25a-b follows the voltage at the second input 26a-b. Depending on the particular amplifier configuration, the potential at the first input 25a-b may be substantially the same as the potential at the second input 26a-b, or there may be a substantially fixed offset between the potential at the first input 25a-b and the potential at the second input 26a-b. In the configuration of FIG. 3, the first input 25a-b of the charge amplifier is virtually grounded.

When a time-varying potential is provided to the finger 15 by the excitation signal providing circuitry 19, a corresponding time-varying potential difference occurs between the sensing structure 17a-b and the finger 15.

The above-described change in potential difference between the finger 15 and the sensing structure 17a-b results in a sensing voltage signal Vₛ on the output 27a-b of the charge amplifier 18a-b.

When the indicated sensing element 13a-b is selected for sensing, the selection switch 21a-b is closed to provide the sensing signal to the readout line 33. The readout line 33, which may be a common readout line for a row or a column of the sensor array 5 in FIG. 2, is shown in FIG. 3 to be connected to a multiplexer 36. As is schematically indicated in FIG. 3, additional readout lines from other rows/columns of the sensor array 5 may also be connected to the multiplexer 36.

The output of the multiplexer 36 is connected to a sample-and-hold circuit 37 and an analog-to-digital converter 38 in series for sampling and converting the analog signals originating from the sensing elements 13a-b to a digital representation of the fingerprint pattern of the finger 15 on the sensor 2.

As is schematically indicated in FIG. 3, the finger detection circuit 12 here comprises a dedicated finger detecting structure 11b in the form of a metal plate, a charge amplifier 40 and a detection signal processing circuit 41. The charge amplifier 40, which is similar in principle to the charge amplifiers 18a-b comprised in the sensing elements 13a-b described above.

Accordingly, the charge amplifier 40 comprises at least one amplifier stage, here schematically illustrated as an operational amplifier (op amp) 44 having a first input (negative input) 45 connected to the finger detecting structure 11b, a second input (positive input) 46 connected to sensor ground or another reference potential, and an output 47. In addition, the charge amplifier 40 comprises a feedback capacitor 49 connected between the first input 45 and the output 47, and reset circuitry, here functionally illustrated as a switch 50, for allowing controllable discharge of the feedback capacitor 49. The charge amplifier may be reset by operating the reset circuitry 50 to discharge the feedback capacitor 49. As is also indicated in FIG. 3, the output of the charge amplifier is a finger detection signal S_{d} (in the form of a voltage) indicative of the capacitive coupling between the finger 15 and the finger detecting structure 11b.

In FIG. 3, the finger 15 is shown as being connected to an excitation circuit 19 for providing the desired potential difference between the finger, and the sensing plates 17a-b of the sensor array 5 and the finger detecting structure 4a. It should be noted that this desired potential difference may alternatively be provided by changing the ground level of the fingerprint sensing device in relation to the ground level of the electronic device (such as mobile phone 1) in which the fingerprint sensing device 3 is included.

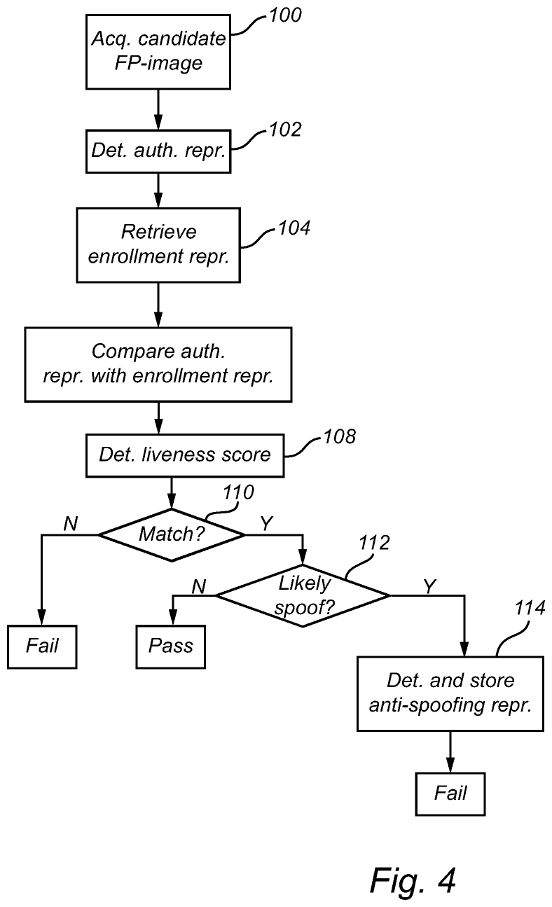

A first exemplary embodiment of a method according to an aspect of the present invention will now be described with reference to the flow-chart in FIG. 4 together with illustrations in other figures where applicable.

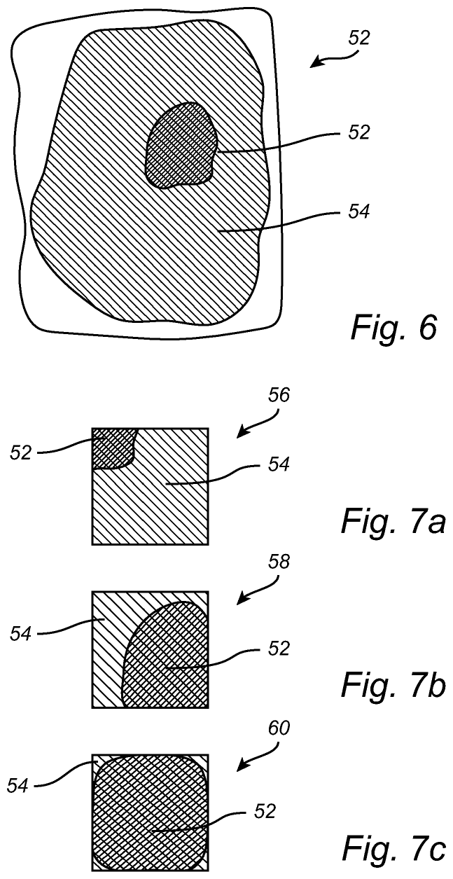

In a first step 100, a first candidate fingerprint image of the candidate finger probe is acquired using the fingerprint sensor 3. The candidate finger probe may be a real finger, or a spoof that may have been manufactured based on a latent print. A schematic illustration of such a spoof 50 is provided in FIG. 6.

Referring now briefly to FIG. 6, such a spoof 50 may have a first spoof portion 52 in which the topography is similar to that of the real finger, and a second spoof portion 54 that differs, in various ways, from the real finger.

Since the sensing area of the fingerprint sensor 3 is considerably smaller than the candidate finger probe, only a portion of the candidate finger probe will be imaged by the fingerprint sensor 3 as the above-mentioned first candidate fingerprint image. Assuming in the following that the candidate finger probe is the spoof 50 in FIG. 6 and that a so-called presentation attack is taking place, an example first fingerprint image 56 acquired in connection with a first authentication attempt is schematically shown in FIG. 7a. FIG. 7b schematically shows an example second fingerprint image 58 acquired in connection with a second authentication attempt, and FIG. 7c schematically shows an example third fingerprint image 60 acquired in connection with a third authentication attempt.

Returning to the flow-chart in FIG. 4, a first authentication representation is determined based on the first candidate fingerprint image 56 in step 102. A stored enrollment representation of an enrolled fingerprint of the user is retrieved in step 104, and the first authentication representation is compared with the enrollment representation in the subsequent step 106. Since various ways of forming suitable biometric representations based on fingerprint images as well as various ways of comparing such biometric representations to determine a match score are well known in the art, no detailed description of this is provided here.

Subsequently (or any time after receiving the touch by the candidate finger probe), in step 108, a liveness score is determined. There are various well-known ways of determining a liveness score. For instance, the candidate fingerprint image may be analyzed in view of various properties of the enrolled fingerprint, such as ridge dimensions, the presence and distribution of sweat pores, the existence of perspiration etc. According to other known ways of determining a liveness score, auxiliary sensors may be used for detecting one or several properties of the candidate finger probe. It could, for instance, be feasible to use the above-described finger detection circuitry to obtain a measure indicative of electrical properties of the candidate finger probe.

In the next step 110 it is determined whether or not the first authentication representation and the enrollment representation match. For instance, a match score may be determined indicating the similarity between the first authentication representation and the enrollment representation, and the match score may be compared with a threshold that may be predefined or adaptive.

If it is determined in step 110 that there is no match, it is concluded that the authentication attempt failed, as indicated in FIG. 4. This may, for example, be the case for the first example fingerprint image 56 shown in FIG. 7a. If it is instead determined in step 110 that there is a match, the method proceeds to step 112 to evaluate the above-mentioned liveness score. This may, for example, be the case for the second example fingerprint image 58 shown in FIG. 7b.

If the liveness score indicates that the candidate finger probe is likely to be a real finger, it is concluded that the authentication attempt was successful, indicated by ‘Pass’ in FIG. 4. This would probably not be the case for the second example fingerprint image 58 shown in FIG. 7b because a substantial part of the second example fingerprint image 58 images the above-mentioned second spoof portion 54 (in FIG. 6) that differs, in various ways, from the real finger.

Instead, it is likely that the liveness score for the second example fingerprint image 58 would indicate a likely spoof. The method then proceeds to step 114 where an anti-spoofing representation is determined based on the first candidate fingerprint image (here the second example fingerprint image 58 in FIG. 7b). The anti-spoofing representation is stored in memory (for example included in the processing circuitry 7), and it is concluded that the authentication attempt failed.

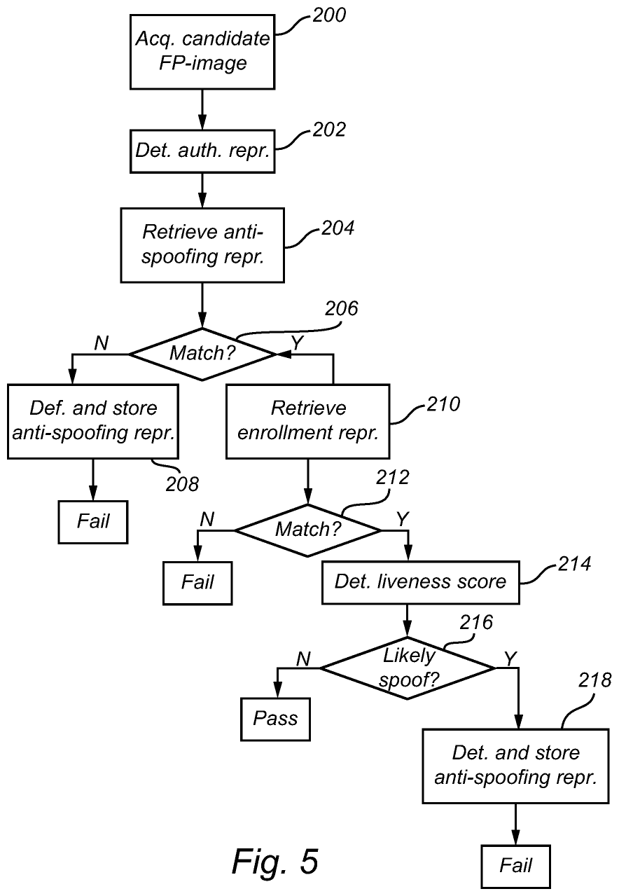

A second exemplary embodiment of a method according to an aspect of the present invention will now be described with reference to the flow-chart in FIG. 5 together with illustrations in other figures where applicable.

In a first step 200, a candidate fingerprint image of the candidate finger probe is acquired using the fingerprint sensor 3. The candidate finger probe may be a real finger, or a spoof that may have been made based on a latent print. As mentioned above, a schematic illustration of such a spoof 50 is provided in FIG. 6.

An authentication representation is determined based on the candidate fingerprint image in step 202. A stored anti-spoofing representation determined in connection with one or several previous authentication attempt(s) is retrieved in step 204.

Subsequently, in step 206, the authentication representation and the anti-spoofing representation are compared, and it is determined if there is a match. Assuming that the acquired candidate fingerprint image is the third example fingerprint image 60 in FIG. 7c, and that the anti-spoofing representation was determined based on the second example fingerprint image 58 in FIG. 7b, it is likely that at least the ‘good’ portions 52 would provide for a match. It is then concluded that the acquired candidate fingerprint image (even though it looks good) is very likely to come from a previously identified spoof 5. In that case, as is indicated in FIG. 5, the method proceeds to step 208 where an anti-spoofing representation is determined based on the candidate fingerprint image (here the third example fingerprint image 60 in FIG. 7c). The anti-spoofing representation is stored in memory together with previously stored anti-spoofing representation(s) or replacing a previously stored anti- spoofing representation, and it is concluded that the authentication attempt failed.

This result is significant, because the third example fingerprint image 60 in FIG. 7c may include so much of the ‘good’ portion 52 of the spoof 50 that the authentication attempt could possibly have passed both an enrollment matching and a liveness test and resulted in a successful authentication, had it not been for the stored anti-spoofing representation associated with a previous authentication attempt.

If there is no anti-spoofing match in step 206, the example method in FIG. 5 instead proceeds to step 210, where an enrollment representation is retrieved, and enrollment matching is carried out by comparing the authentication representation with the enrollment representation in the subsequent step 212.

If it is determined in step 212 that there is no enrollment match, it is concluded that the authentication attempt failed, as indicated in FIG. 5. If it is instead determined in step 212 that there is a match, the method proceeds to step 214 to determine a liveness score.

The liveness score is evaluated in step 216. If the liveness score indicates that the candidate finger probe is likely to be a real finger, it is concluded that the authentication attempt was successful, indicated by ‘Pass’ in FIG. 5. If, as is described above in connection with the flow-chart in FIG. 4, the liveness score instead indicates a likely spoof, the method then proceeds to step 218 where an anti-spoofing representation is determined based on the candidate fingerprint image. The anti-spoofing representation is stored in memory (for example included in the processing circuitry 7), and it is concluded that the authentication attempt failed.

The person skilled in the art realizes that the present invention by no means is limited to the preferred embodiments described above. On the contrary, many modifications and variations are possible within the scope of the appended claims. For example, the above-described liveness evaluation may take place before the authentication matching.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A method of authenticating a user by means of a fingerprint authentication system, said method comprising the steps of:
receiving a touch by a candidate finger probe;
acquiring a first candidate fingerprint image indicating a surface topography of said candidate finger probe;
determining a first authentication representation based on said first candidate fingerprint image;
retrieving a stored enrollment representation of an enrolled fingerprint of said user;
comparing said first authentication representation with said enrolment representation;
determining a liveness score for said candidate finger probe; and
when said liveness score indicates a likely spoof:
providing a signal indicating a failed authentication;
determining a first anti-spoofing representation based on said first candidate fingerprint image; and
storing said first anti-spoofing representation.

2. The method according to claim 1, further comprising the steps of:
acquiring a second candidate fingerprint image indicating a surface topography of said candidate finger probe;
determining a second authentication representation based on said second candidate fingerprint image;
retrieving the stored first anti-spoofing representation;
comparing said second authentication representation with said first anti-spoofing representation; and
when said second authentication representation matches with said first anti-spoofing representation, providing a signal indicating a failed authentication.

3. The method according to claim 2, further comprising the step of:
when said second authentication representation matches with said first anti-spoofing representation:
determining a second anti-spoofing representation based on said second candidate fingerprint image; and
storing said second anti-spoofing representation.

4. The method according to claim 2, wherein said first candidate fingerprint image is acquired in connection with a first authentication attempt, and said second candidate fingerprint image is acquired in connection with a second authentication attempt.

5. The method according to claim 4, wherein a determination of whether or not said second authentication representation matches with said first anti-spoofing representation depends on a time between said first authentication attempt and said second authentication attempt.

6. The method according to claim 5, wherein said determination depends on the time between said first authentication attempt and said second authentication attempt in such a way that a shorter time increases a likelihood of said second authentication representation matching with said first anti-spoofing representation.

7. The method according to claim 1, further comprising the steps of:
discarding any stored anti-spoofing representation upon receiving an indication of a successful authentication by the user.

8. The method according to claim 7, wherein said successful authentication of the user is by means of an alternative authentication method, such as a successful passcode entry.

9. The method according to claim 1, wherein said liveness score is determined based on at least one acquired candidate fingerprint image.

10. The method according to claim 1, wherein:
said fingerprint authentication system comprises liveness sensing circuitry for sensing a liveness property of said candidate finger probe; and
said liveness score is based on said liveness property.

11. The method according to claim 10, wherein said liveness property is selected from a set of properties of said candidate finger probe including:
a dimension;
a relation between dimensions;
a deformation property;
an optical property
an electrical property; and
a perspiration property.

12. A fingerprint authentication system for authenticating a user, comprising:
a fingerprint sensing arrangement;
a memory; and
processing circuitry coupled to said fingerprint sensing arrangement, said processing circuitry being configured to:
control said fingerprint sensing arrangement to acquire a first candidate fingerprint image indicating a surface topography of a candidate finger probe;
determine a first authentication representation based on said first candidate fingerprint image;
retrieve, from said memory, a stored enrollment representation of an enrolled fingerprint of said user;
compare said first authentication representation with said enrolment representation;
determine a liveness score for said candidate finger probe; and
when said first authentication representation matches with said enrolment representation, and said liveness score indicates a likely spoof:
provide a signal indicating a failed authentication;
determine a first anti-spoofing representation based on said first candidate fingerprint image; and
store, in said memory, said first anti-spoofing representation.

13. The fingerprint authentication system according to claim 12, wherein:
said fingerprint sensing arrangement comprises liveness sensing circuitry for providing a liveness signal indicative of a liveness property of said candidate finger probe; and
said processing circuitry is further configured to determine said liveness score based on said liveness signal.

14. An electronic device comprising;
a fingerprint authentication system according to claim 12; and
a processing unit configured to control said fingerprint authentication system to carry out a fingerprint authentication of a user, and to perform at least one action only upon successful authentication of said user.
